(19) United States
(12) Patent Application Publication
(10) Pub. No.: US 2026/0267718 A1
(43) Pub. Date: Sep. 10, 2026

(54) INFORMATION PROCESSING SYSTEM, NON-TRANSITORY COMPUTER READABLE MEDIUM STORING PROGRAM, AND INFORMATION PROCESSING METHOD

(71) Applicant: FUJIFILM Business Innovation Corp., Tokyo (JP)

(72) Inventors: Shunji TSUNASHIMA, Kanagawa (JP); Nobukazu MIYOSHI, Kanagawa (JP); Ibuki KURODA, Kanagawa (JP)

(73) Assignee: FUJIFILM Business Innovation Corp., Tokyo (JP)

(21) Appl. No.: 19/256,047

(22) Filed: Jun. 30, 2025

(30) Foreign Application Priority Data
Mar. 4, 2025 (JP) 2025-033639

(51) Int. Cl. G06F 9/54

(52) U.S. Cl. CPC G06F 9/544

(57) ABSTRACT

An information processing system includes a processor, a functional module that performs information processing in cooperation with the processor, a shared memory for writing a command for controlling the functional module in controlling the functional module via the processor, the shared memory being used by both of the processor and the functional module, and a detection unit that detects whether or not a command in the shared memory is corrupted, in which the processor is configured to, in writing plural commands for controlling the functional module into the shared memory, write the plural commands together with digest values derived from each of the commands and provide notification of a start of processing to the functional module and the detection unit, and the detection unit receives the notification of the start of processing from the processor, collectively reads the plural commands written in the shared memory and plural digest values corresponding to the plural commands from the shared memory, performs comparison processing to determine whether or not a digest value calculated from the read command matches the read digest value for each command, and transmits the read command and a result of the comparison processing to the functional module.

### CROSS-REFERENCE TO RELATED APPLICATIONS

This application is based on and claims priority under 35 USC 119 from Japanese Patent Application No. 2025-033639 filed Mar. 4, 2025.

### BACKGROUND

### (i) Technical Field

The present disclosure relates to an information processing system, a non-transitory computer readable medium storing a program, and an information processing method.

### (ii) Related Art

JP2007-219802A discloses a storage device that provides content protection by detecting tampering of stored data to increase safety of the data.

### SUMMARY

In an information processing system including a processor, a functional module that performs information processing in cooperation with the processor, and a shared memory used by both of the processor and the functional module, in a case where the functional module reads a command written in the shared memory by the processor and performs an operation in accordance with content of the command, the functional module performs an abnormal operation corresponding to a corrupted command in a case where the command in the shared memory is corrupted by being overwritten with a different value for any reason.

In order to prevent such an abnormal operation, providing a detection unit that detects whether or not the command in the shared memory is corrupted in advance before executing the command via the functional module is considered.

Specifically, the processor is configured to, in writing the command into the shared memory, add a digest value derived from the command to the command, write the command, and then provide notification of the start of processing to the functional module.

In a case where the functional module receives the notification, the functional module transmits a command read request to the detection unit for each command. In a case where the detection unit receives the command read request, the detection unit reads the command and the digest value from the shared memory, performs comparison to determine whether or not the digest value derived from the read command matches the read digest value, and returns a result to the functional module. The functional module determines whether to execute or stop the operation in accordance with the received result.

However, such detection of the corrupted command results in additional processing such as derivation processing of the digest value from the command and comparison processing between the derived digest value and the reference digest value. Thus, an issue arises in that a processing time in the functional module is extended compared to the processing time in the case of not detecting the corrupted command.

Aspects of non-limiting embodiments of the present disclosure relate to an information processing system, a non-transitory computer readable medium storing a program, and an information processing method that can reduce a processing time in a functional module compared to the processing time in a case where a detection unit receives a command read request from a functional module for each command and reads a command and a digest value from a shared memory.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing system including a processor, a functional module that performs information processing in cooperation with the processor, a shared memory for writing a command for controlling the functional module in controlling the functional module via the processor, the shared memory being used by both of the processor and the functional module, and a detection unit that detects whether or not a command in the shared memory is corrupted, in which the processor is configured to, in writing a plurality of commands for controlling the functional module into the shared memory, write the plurality of commands together with digest values derived from each of the commands and provide notification of a start of processing to the functional module and the detection unit, and the detection unit receives the notification of the start of processing from the processor, collectively reads the plurality of commands written in the shared memory and a plurality of digest values corresponding to the plurality of commands from the shared memory, performs comparison processing to determine whether or not a digest value calculated from the read command matches the read digest value for each command, and transmits the read command and a result of the comparison processing to the functional module.

### BRIEF DESCRIPTION OF THE DRAWINGS

Exemplary embodiment(s) of the present invention will be described in detail based on the following figures, wherein:

FIG. 1 is an exterior view of an image forming apparatus according to one exemplary embodiment;

FIG. 2 is a block diagram illustrating a hardware configuration of the image forming apparatus;

FIG. 3 is a diagram for describing processing of the image forming apparatus of the present exemplary embodiment;

FIG. 4 is a diagram for describing processing of an image forming apparatus of a comparative example; and

FIG. 5 is a diagram for describing a processing time in a case where a plurality of commands are stored in a functional module of each of the image forming apparatus of the present exemplary embodiment and the image forming apparatus of the comparative example.

### DETAILED DESCRIPTION

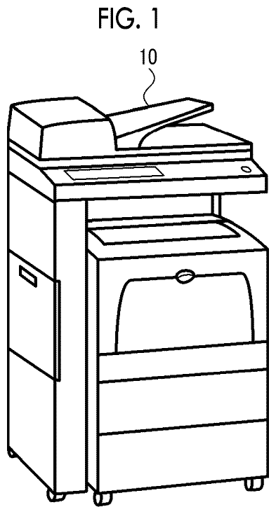

Hereinafter, an exemplary embodiment of the technology of the present disclosure will be described in detail with reference to the drawings. FIG. 1 is an exterior view of an image forming apparatus 10 according to one exemplary embodiment.

As illustrated in FIG. 1, the image forming apparatus 10 is a so-called multifunction peripheral having a plurality of functions such as a copy function, a print function, a fax function, and a scan function. The image forming apparatus 10 is an example of an information processing system in the technology of the present disclosure.

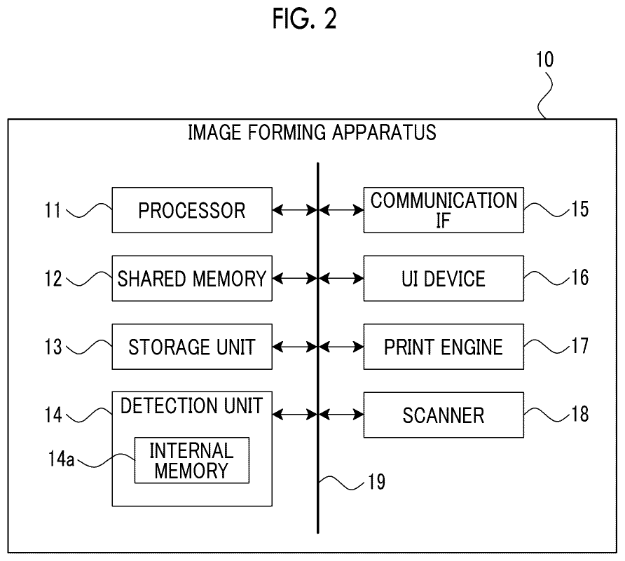

Next, a hardware configuration of the image forming apparatus 10 of the present exemplary embodiment will be described. FIG. 2 is a block diagram illustrating the hardware configuration of the image forming apparatus 10.

As illustrated in FIG. 2, the image forming apparatus 10 includes a processor 11, a shared memory 12, a storage unit 13, a detection unit 14, a communication interface (hereinafter, abbreviated to communication IF) 15, a user interface device (hereinafter, abbreviated to UI device) 16, a print engine 17, and a scanner 18. These constituents are connected to each other via a control bus 19.

The communication IF 15 transmits and receives data to and from an external apparatus or the like. The UI device 16 includes a touch panel, a physical button, and the like, and receives an instruction input from a user. The print engine 17 prints an image on a recording medium such as a printing paper sheet through steps of electrostatic charging, exposure, development, transfer, and fixing. The scanner 18 scans a document loaded in the image forming apparatus 10 as image data. Each of the communication IF 15, the UI device 16, the print engine 17, and the scanner 18 is an example of a functional module in the technology of the present disclosure.

The processor 11 executes predetermined processing based on a program that is read from the storage unit 13 and loaded into the shared memory 12.

The storage unit 13 is configured with, for example, a read only memory (ROM), a hard disk drive (HDD), or a solid state drive (SSD). The storage unit 13 stores a program, data, and the like.

In the present exemplary embodiment, the processor 11 is described as reading and executing the program stored in the storage unit 13. However, the present disclosure is not limited to this. The program may be provided in the form of a recording on a computer readable recording medium. For example, the program may be provided in the form of a recording on an optical disc such as a compact disc (CD)-read only memory (ROM) or a digital versatile disc (DVD)-ROM, or in the form of a recording in a semiconductor memory such as a universal serial bus (USB) memory and a memory card. Alternatively, the program may be acquired from an external apparatus via the communication IF 15.

The shared memory 12 is a shared memory used by both of the processor 11 and each functional module. The shared memory 12 includes two ring buffer regions, and a command for controlling each functional module via the processor 11 and a digest value derived from the command are written into different ring buffer regions.

The detection unit 14 detects whether or not the command in the shared memory 12 is corrupted. The detection unit 14 includes an internal memory 14a.

In the image forming apparatus 10 of the present exemplary embodiment, each functional module such as the communication IF 15, the UI device 16, the print engine 17, and the scanner 18 reads the command written in the shared memory 12 by the processor 11 and performs an operation in accordance with content of the command.

In a case where the command in the shared memory 12 is corrupted by being overwritten with a different value for any reason, the functional module performs an abnormal operation corresponding to the corrupted command. In order to prevent such an abnormal operation, the detection unit 14 detects whether or not the command in the shared memory 12 is corrupted in advance before executing the command via the functional module.

Specifically, in writing the command into the shared memory 12, the processor 11 adds the digest value derived from the command to the command, writes the command, and then provides notification of the start of processing to the functional module. In a case where the functional module receives the notification, the functional module transmits a command read request to the detection unit 14.

In a case where the detection unit 14 receives the command read request, the detection unit 14 reads the command and the digest value from the shared memory, performs comparison to determine whether or not the digest value derived from the read command matches the read digest value, and returns a result to the functional module. The functional module determines whether to execute or stop the operation in accordance with the received result. Accordingly, the functional module can be prevented from performing an abnormal operation corresponding to the corrupted command.

However, a processing time in the functional module is required to be as short as possible.

In order to meet such a requirement, in writing a plurality of commands for controlling the functional module into the shared memory 12, the processor 11 of the image forming apparatus 10 of the present exemplary embodiment writes the plurality of commands together with the digest values derived from each command and provides notification of the start of processing to the functional module and the detection unit 14.

The detection unit 14 receives the notification of the start of processing from the processor 11, collectively reads the plurality of commands written in the shared memory 12 and the plurality of digest values corresponding to the plurality of commands from the shared memory 12, performs comparison processing to determine whether or not the digest value calculated from the read command matches the read digest value for each command, and transmits the read command and a result of the comparison processing to the functional module.

Here, the digest value is called a hash value and means a value obtained by applying a predetermined function to command data. In the image forming apparatus 10 of the present exemplary embodiment, the function for deriving the digest value is not particularly limited, and any function may be used.

In the image forming apparatus 10 of the present exemplary embodiment, the detection unit 14 includes the internal memory 14a and stores the command read from the shared memory 12 and a comparison result of the digest value of the command in the internal memory 14a. The detection unit 14 receives the command read request from the functional module and transmits the command and the comparison result of the digest value of the command stored in the internal memory 14a to the functional module.

The processor 11 writes the command and the digest value into different ring buffer regions in the shared memory 12.

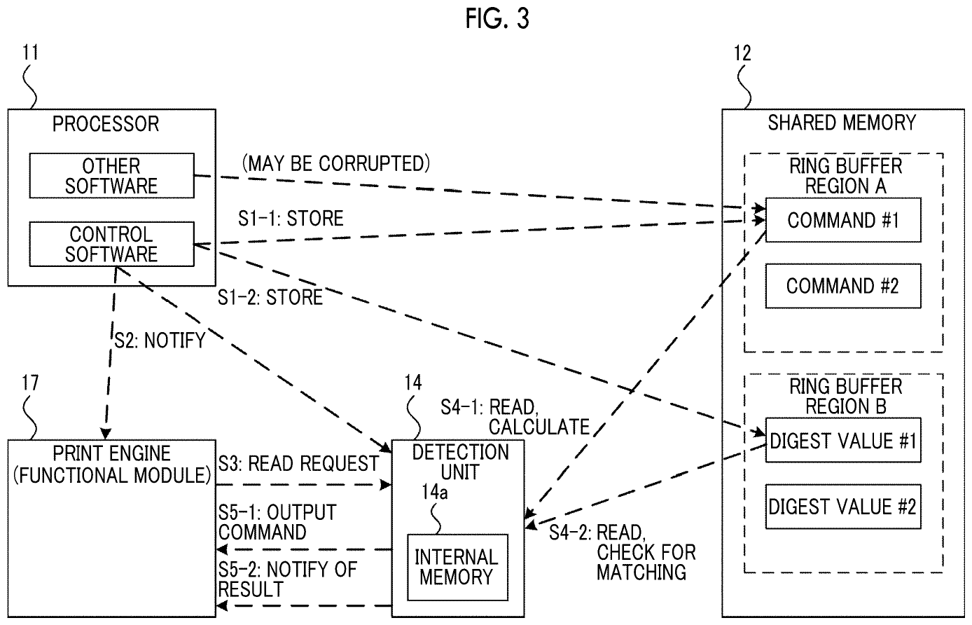

Hereinafter, processing of the image forming apparatus 10 of the present exemplary embodiment will be described in detail with reference to FIGS. 3 to 5.

The functional module for which the detection unit 14 detects an abnormality may correspond to all of the functional modules included in the image forming apparatus 10 or a part of the functional modules. For example, in a case where the functional module for which the abnormality is detected corresponds to a part of the functional modules, the detection unit 14 preferably detects the abnormality for the functional module that is more affected by the abnormality than other functional modules, such as the print engine 17. Here, an example of detecting the abnormality in controlling the print engine 17 as the functional module for which the detection unit 14 detects the abnormality will be described.

As illustrated in FIG. 3, in steps S1-1 and S1-2, functional module control software that operates on the processor 11 stores the plurality of commands in a ring buffer region A in the shared memory 12 and stores each of the digest values calculated from each command in a ring buffer region B.

Next, in step S2, the functional module control software operating on the processor 11 provides command storage notification to each of the print engine 17 and the detection unit 14.

In response to the command storage notification in step S2 as a trigger, the detection unit 14 first reads the first command in the ring buffer region A in the shared memory 12 and stores the command in the internal memory 14a while calculating the digest value in step S4-1.

Next, in step S4-2, the detection unit 14 reads the first digest value in the ring buffer region B in the shared memory 12, performs comparison to determine whether or not the read digest value matches the calculated digest value, and stores the comparison result in the internal memory 14a.

In a case where the command storage notification indicating that the plurality of commands are stored is provided in step S2, the detection unit 14 then repeats the processing in steps S4-1 and S4-2.

In response to the command storage notification in step S2, the print engine 17 issues the command read request to the detection unit 14 in step S3.

In response to the command read request in step S3, the detection unit 14 first outputs the command stored in the internal memory 14a to the print engine 17 in step S5-1.

Next, in step S5-2, the detection unit 14 outputs the comparison result of the digest value stored in the internal memory to the print engine 17.

In a case where the command storage notification indicating that the plurality of commands are stored is provided in step S2, the print engine 17 then issues the command read request in step S3 to the detection unit 14 and repeats processing of acquiring the command and the comparison result of the digest value from the detection unit 14 in steps S5-1 and S5-2.

That is, in the image forming apparatus 10 of the present exemplary embodiment, the detection unit 14 receives the command storage notification from the processor 11 and collectively reads the plurality of commands written in the shared memory 12 and the plurality of digest values corresponding to the plurality of commands from the shared memory 12.

Here, a case where a detection unit 114 receives the command read request for each command from a print engine 117 and reads the command and the digest value from a shared memory 112 in processing the plurality of commands will be described as an image forming apparatus of a comparative example.

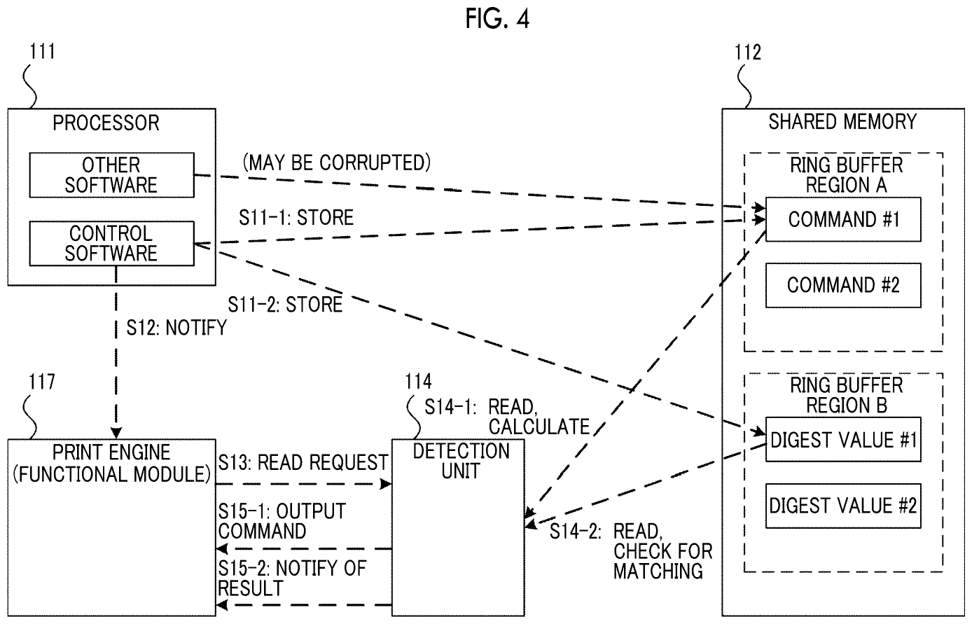

As illustrated in FIG. 4, in steps S11-1 and S11-2, functional module control software that operates on a processor 111 stores the plurality of commands in the ring buffer region A in the shared memory 112 and stores each of the digest values calculated from each command in the ring buffer region B.

Next, the functional module control software operating on the processor 111 provides command storage notification to the print engine 117 in step S12.

In response to the command storage notification in step S12, the print engine 117 issues the command read request for the first command to the detection unit 114 in step S13.

In response to the command read request in step S13 as a trigger, the detection unit first reads the first command in the ring buffer region A in the shared memory 112 and calculates the digest value in step S14-1.

Next, in step S14-2, the detection unit 114 reads the first digest value in the ring buffer region B in the shared memory 112 and performs comparison to determine whether or not the read digest value matches the calculated digest value.

Next, in step S15-1, the detection unit 114 outputs the command read from the ring buffer region A in the shared memory 112 to the print engine 117.

Next, in step S15-2, the detection unit 114 outputs the comparison result of the digest value in step S14-2 to the print engine 117.

In a case where the command storage notification indicating that the plurality of commands are stored is provided in step S12, the detection unit 114 then repeats the processing in steps S13, S14-1, S14-2, S15-1, and S15-2.

Next, the processing time in a case where the plurality of commands are stored in the functional module of each of the image forming apparatus 10 of the present exemplary embodiment and the image forming apparatus of the comparative example will be described.

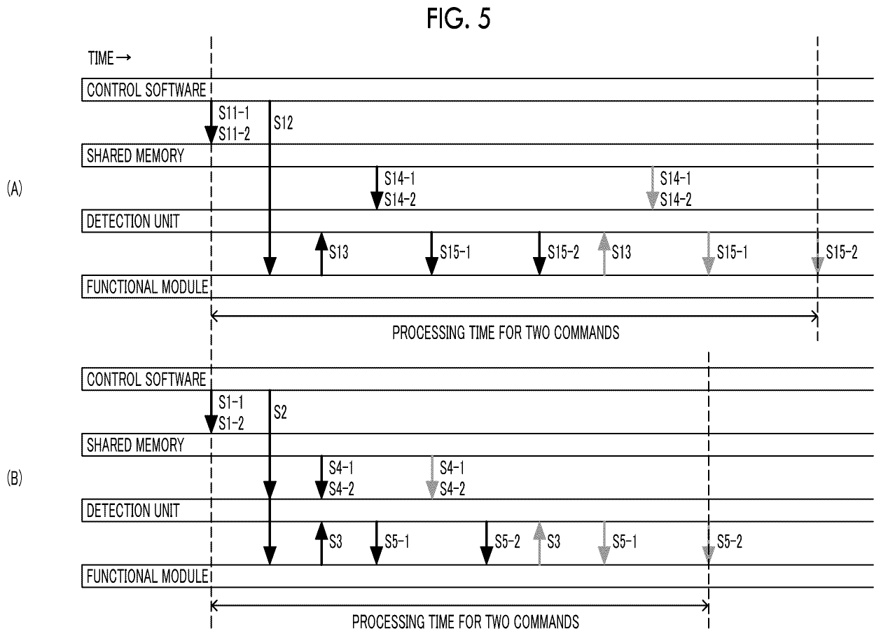

First, the processing time in the functional module of the image forming apparatus of the comparative example will be described. In the image forming apparatus of the comparative example, as illustrated in a part (A) in FIG. 5, after the print engine 117 receives the command storage notification in step S12, the print engine 117 repeats the processing in steps S13, S14-1, S14-2, S15-1, and S15-2 for each command.

Meanwhile, in the image forming apparatus 10 of the present exemplary embodiment, as illustrated in a part (B) in FIG. 5, the detection unit 14 receives the command storage notification in step S2 and collectively reads the plurality of commands written in the shared memory 12 and the plurality of digest values corresponding to the plurality of commands from the shared memory 12 without waiting for the command read request from the print engine 17.

Thus, in a case where the detection unit 14 receives the command read request from the print engine 17, the detection unit 14 may immediately transmit the command and the comparison result of the digest value to the print engine 17.

Accordingly, in the image forming apparatus 10 of the present exemplary embodiment, the processing time in the print engine 17 (an example of the functional module) is shorter than the processing time in the image forming apparatus of the comparative example.

### Modification Example

While the image forming apparatus of one exemplary embodiment of the information processing system of the present disclosure is described above, the technology of the present disclosure is not limited to the exemplary embodiment and can be modified, as appropriate.

For example, the technology of the present disclosure is not limited to the image forming apparatus and may be applied to any system as long as the system is an information processing system including a functional module that performs information processing in cooperation with a processor.

In the exemplary embodiments, the processes are performed by any computer. The computer may perform the processes by using a processor serving as hardware, a program serving as software, or combination of these. In this case, the processor is configured to perform the processes in the exemplary embodiments in cooperation with the program and may function as a unit or a means in the exemplary embodiments. The order in which the processor performs the processes is not limited to the described order and may be changed appropriately. The computer may be a general-purpose computer, an application specific computer, a workstation, or another system capable of performing the processes.

The processor may be composed of one or more pieces of hardware, and the type of the hardware is not limited. For example, the processor may be composed of hardware such as a central processing unit (CPU), a micro processing unit (MPU), a programmable logic device such as a field programmable gate array (FPGA), a dedicated circuit for performing specific processing such as an application specific integrated circuit (ASIC), a graphics processing unit (GPU), or a neural processing unit (NPU). Regarding the type of the hardware, different types of hardware may be combined. If multiple pieces of hardware are configured to perform one or more processes of the processor, the multiple pieces of hardware may be present in apparatuses physically away from each other or may be present in one apparatus. In each of exemplary embodiments, the order in which the processor performs the processes is not limited to the order described above and may be changed appropriately. The hardware is composed of electric circuitry in which circuit elements such as semiconductor devices are combined, or the like.

Further, the program may be software such as firmware or microcode. The program may be, for example, a program module group, and the functions thereof may be implemented by processors configured to implement the respective functions. The program may be program code or multiple code segments stored in one or more non-transitory computer readable media (for example, a storage medium or another storage). The program may be stored in such a divided manner in multiple non-transitory computer readable media present in apparatuses physically away from each other. The program code or the code segments may represent a procedure, a function, a sub program, a routine, a subroutine, a module, a software package, a class or any combination of instructions, data structures, or program statements. The program code or the code segment may be connected to another code segment or a hardware circuit by transmitting and/or receiving information, data, an argument, a parameter, or memory content.

In the technology of the present disclosure, the system includes both of a system configured with a plurality of apparatuses and a system configured with a single apparatus.

The technology of the present disclosure can also be applied to a program and a program product.

### Supplementary Note

The following appendices are further disclosed with respect to the above exemplary embodiment.
(((1))) An information processing system comprising:
   a processor;
   a functional module that performs information processing in cooperation with the processor;
   a shared memory for writing a command for controlling the functional module in controlling the functional module via the processor, the shared memory being used by both of the processor and the functional module; and
   a detection unit that detects whether or not a command in the shared memory is corrupted,
   wherein the processor is configured to:
      in writing a plurality of commands for controlling the functional module into the shared memory, write the plurality of commands together with digest values derived from each of the commands and provide notification of a start of processing to the functional module and the detection unit, and
   the detection unit receives the notification of the start of processing from the processor, collectively reads the plurality of commands written in the shared memory and a plurality of digest values corresponding to the plurality of commands from the shared memory, performs comparison processing to determine whether or not a digest value calculated from the read command matches the read digest value for each command, and transmits the read command and a result of the comparison processing to the functional module.
(((2))) The information processing system according to (((1))),
   wherein the detection unit includes a memory and stores the command read from the shared memory and a comparison result of the digest value of the command in the memory.
(((3))) The information processing system according to (((2))),
   wherein the detection unit receives a command read request from the functional module and transmits the command and the comparison result of the digest value of the command stored in the memory to the functional module.
(((4))) The information processing system according to any one of (((1))) to (((3))), wherein the processor is configured to:
   write the command and the digest value into a ring buffer in the shared memory.
(((5))) The information processing system according to (((4))), wherein the processor is configured to:
   write the command and the digest value into different ring buffers.
(((6))) A program for controlling a processor and a detection unit in an information processing system including a processor, a functional module that performs information processing in cooperation with the processor, a shared memory for writing a command for controlling the functional module in controlling the functional module via the processor, the shared memory being used by both of the processor and the functional module, and a detection unit that detects whether or not a command in the shared memory is corrupted, the program causing a computer to execute a process comprising:
   writing, in the processor, in writing a plurality of commands for controlling the functional module into the shared memory, the plurality of commands together with digest values derived from each of the commands and providing notification of a start of processing to the functional module and the detection unit; and
   receiving, in the detection unit, the notification of the start of processing from the processor, collectively reading the plurality of commands written in the shared memory and a plurality of digest values corresponding to the plurality of commands from the shared memory, performing comparison processing to determine whether or not a digest value calculated from the read command matches the read digest value for each command, and transmitting the read command and a result of the comparison processing to the functional module.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing system comprising:
a processor;
a functional module that performs information processing in cooperation with the processor;
a shared memory for writing a command for controlling the functional module in controlling the functional module via the processor, the shared memory being used by both of the processor and the functional module; and
a detection unit that detects whether or not a command in the shared memory is corrupted,
wherein the processor is configured to:
in writing a plurality of commands for controlling the functional module into the shared memory, write the plurality of commands together with digest values derived from each of the commands and provide notification of a start of processing to the functional module and the detection unit, and
the detection unit receives the notification of the start of processing from the processor, collectively reads the plurality of commands written in the shared memory and a plurality of digest values corresponding to the plurality of commands from the shared memory, performs comparison processing to determine whether or not a digest value calculated from the read command matches the read digest value for each command, and transmits the read command and a result of the comparison processing to the functional module.

2. The information processing system according to claim 1,
wherein the detection unit includes a memory and stores the command read from the shared memory and a comparison result of the digest value of the command in the memory.

3. The information processing system according to claim 2,
wherein the detection unit receives a command read request from the functional module and transmits the command and the comparison result of the digest value of the command stored in the memory to the functional module.

4. The information processing system according to claim 1, wherein the processor is configured to:
write the command and the digest value into a ring buffer in the shared memory.

5. The information processing system according to claim 4, wherein the processor is configured to:
write the command and the digest value into different ring buffers.

6. A non-transitory computer readable medium storing a program for controlling a processor and a detection unit in an information processing system including a processor, a functional module that performs information processing in cooperation with the processor, a shared memory for writing a command for controlling the functional module in controlling the functional module via the processor, the shared memory being used by both of the processor and the functional module, and a detection unit that detects whether or not a command in the shared memory is corrupted, the program causing a computer to execute a process comprising:
writing, in the processor, in writing a plurality of commands for controlling the functional module into the shared memory, the plurality of commands together with digest values derived from each of the commands and providing notification of a start of processing to the functional module and the detection unit; and
receiving, in the detection unit, the notification of the start of processing from the processor, collectively reading the plurality of commands written in the shared memory and a plurality of digest values corresponding to the plurality of commands from the shared memory, performing comparison processing to determine whether or not a digest value calculated from the read command matches the read digest value for each command, and transmitting the read command and a result of the comparison processing to the functional module.

7. An information processing method for controlling a processor and a detection unit in an information processing system including a processor, a functional module that performs information processing in cooperation with the processor, a shared memory for writing a command for controlling the functional module in controlling the functional module via the processor, the shared memory being used by both of the processor and the functional module, and a detection unit that detects whether or not a command in the shared memory is corrupted, the method comprising:
writing, in the processor, in writing a plurality of commands for controlling the functional module into the shared memory, the plurality of commands together with digest values derived from each of the commands and providing notification of a start of processing to the functional module and the detection unit; and
receiving, in the detection unit, the notification of the start of processing from the processor, collectively reading the plurality of commands written in the shared memory and a plurality of digest values corresponding to the plurality of commands from the shared memory, performing comparison processing to determine whether or not a digest value calculated from the read command matches the read digest value for each command, and transmitting the read command and a result of the comparison processing to the functional module.
